(19) United States
(12) Patent Application Publication
(10) Pub. No.: US 2013/0025370 A1
(43) Pub. Date: Jan. 31, 2013

(54) APPARATUS FOR PIPELINE INSPECTION AND METHOD OF PIPELINE INSPECTION

(71) Applicants: William HERRON, Ashington (GB); Robert PALMA, Stutensee (DE)

(72) Inventors: William HERRON, Ashington (GB); Robert PALMA, Stutensee (DE)

(21) Appl. No.: 13/481,234

(22) Filed: May 25, 2012

(30) Foreign Application Priority Data
May 26, 2011 (EP) 11167721.7

(51) Int. Cl. G01N 29/06

(52) U.S. Cl. 73/592

(57) ABSTRACT

An apparatus for pipeline inspection, the apparatus having a longitudinal axis, is provided. The apparatus comprises: a plurality of ultrasonic sensor units arranged for inspection of a pipe wall, each ultrasonic sensor unit comprising an array of ultrasonic sensors, wherein the plurality of ultrasonic sensor units defines two or more groups of ultrasonic sensor units, wherein the groups of ultrasonic sensor units are axially offset from one another with respect to the longitudinal axis of the apparatus, the ultrasonic sensor units in each group being spaced circumferentially from one another, and wherein the ultrasonic sensor units are arranged out of phase, to provide inspection coverage for the circumferential spacing between the sensor units in the groups of ultrasonic sensor units so that the combined output from the groups of sensor units provides 360 degrees of inspection coverage.

### BACKGROUND OF THE INVENTION

1. Field of the Invention

Embodiments of the present invention relate to a pipeline inspection apparatus and a method of pipeline inspection.

2. Description of the Related Art

It is known to carry out an inspection of a pipeline using an apparatus, commonly referred to as a pipeline pig, which travels inside the pipeline, and includes one or more sensors arranged for measuring or detecting defects in the wall of the pipeline.

Wall thickness and cracks in the wall of a liquid-filled pipeline can be measured or detected using ultrasonic sensors, wherein the liquid in the pipeline provides a couple medium for transferring ultrasonic waves from the ultrasonic sensors to the pipe wall.

Typically, the ultrasonic sensors are mounted on a sensor carrier, which is intended to position the ultrasonic sensors adjacent to the pipe wall, for example, as a pig carries out an inspection run through a pipeline. The sensor carrier may consist of or include a skid, which is intended to run immediately adjacent or in contact with an inner surface of the pipe, with the sensors arranged at a stand off from the outer surface of the skid, in order to protect the sensors against wear or other damage from contact with the pipe.

In conventional pipeline inspection apparatus, skids take one of two forms: a skid having a generally helical shape with respect to a longitudinal axis of the apparatus: or a straight skid which extends parallel with or at an angle of inclination to the longitudinal axis of the apparatus.

In each case, the skids can not be adjusted and/or changed during an inspection run without physically stopping the apparatus at a location along the pipeline and carrying out maintenance in situ. Hence, the conventional skids are often unsuitable for use in inspecting a pipeline which has variations in bore diameter along its length. As such, it is generally accepted that a given skid design is only suitable for a single diameter of pipe. Although inspection of dual or multi-diameter lines may sometimes be possible using conventional skid designs, the reliability of results is often poor and requires considerable design effort and/or trial and error to prove its effectiveness.

### BRIEF DESCRIPTION OF THE INVENTION

According to an embodiment of the present invention, an apparatus for pipeline inspection, the apparatus having a longitudinal axis, is provided. The apparatus comprises: a plurality of ultrasonic sensor units arranged for inspection of a pipe wall, each ultrasonic sensor unit comprising an array of ultrasonic sensors, wherein the plurality of ultrasonic sensor units defines two or more groups of ultrasonic sensor units, wherein the groups of ultrasonic sensor units are axially offset from one another with respect to the longitudinal axis of the apparatus, the ultrasonic sensor units in each group being spaced circumferentially from one another, and wherein the ultrasonic sensor units are arranged out of phase, to provide inspection coverage for the circumferential spacing between the sensor units in the groups of ultrasonic sensor units so that the combined output from the groups of sensor units provides 360 degrees of inspection coverage.

According to an embodiment of the present invention, a method is provided for pipeline inspection for a pipeline having a first section with a first bore diameter and a second section with a second bore diameter which is greater than the first bore diameter. The method comprises: providing a pipeline apparatus for in-line inspection of the pipeline, the apparatus having a longitudinal axis and comprising a plurality of ultrasonic sensor units arranged for inspection of a pipe wall, each ultrasonic sensor unit comprising an array of ultrasonic sensors, wherein the plurality of ultrasonic sensor units define an upstream group of sensor units and a downstream group of ultrasonic sensor units, the upstream group being axially offset from the downstream group, wherein the ultrasonic sensor units in the upstream group are spaced circumferentially from one another, the ultrasonic sensor units in the downstream group are spaced circumferentially from one another, and wherein the ultrasonic sensor units in the downstream group are arranged out of phase with the ultrasonic sensor units in the upstream group; sending the apparatus on a continuous run through the first and second sections of the pipeline; and using the ultrasonic sensor units to provide a circumferential inspection of the pipeline in both the first section and the second section, wherein the downstream group of ultrasonic sensor units provides downstream inspection coverage for the circumferential spacing between the ultrasonic sensor units in the upstream group, and the upstream group of ultrasonic sensor units provides upstream inspection coverage for the circumferential spacing between the ultrasonic sensor units in the downstream group.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic perspective view of part of an apparatus for pipeline inspection including multiple vessels, each vessel having multiple sensor units according to an embodiment of the present invention;

FIG. 2 is a simplification of the embodiment shown in FIG. 1 showing only a single vessel, with only a sensor unit and associated biasing mechanism;

FIG. 3 is a schematic perspective view of a sensor unit and carrier for use in the embodiments of FIGS. 1 and 2;

FIG. 4 is a schematic perspective view of the carrier in FIG. 3; and

FIG. 5 is a schematic diagram showing an apparatus of the kind shown in FIG. 1 (but having only one sensor vessel) operable through a pipeline having multiple bore diameters.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

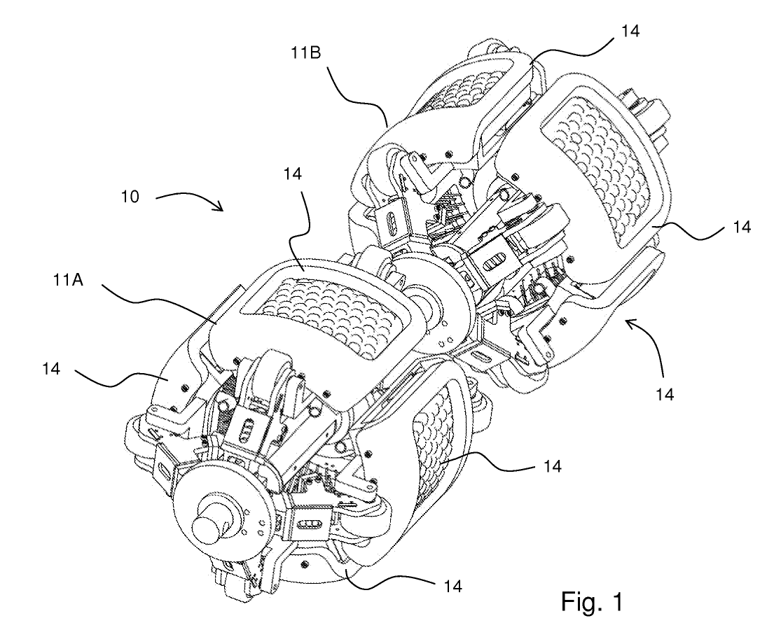

FIG. 1 illustrates part of a pipeline inspection apparatus for in-line inspection of pipelines and is indicated generally at 10. Apparatus 10 includes first and second sensor vessels 11A, 11B, which are coupled for movement together along a pipeline. As viewed in FIG. 1, vessel 11A would be the leading or upstream vessel, in use, with vessel 11B arranged downstream of vessel 11A.

Each vessel 11A, 11B is provided with multiple ultrasonic sensor units 14, each of which is movably mounted in a manner described in more detail below. Each sensor unit 14 includes multiple ultrasonic sensors 16. The sensors 16 define an arcuate inspection array, which extends in a circumferential direction with respect to a longitudinal axis of the apparatus 10.

The ultrasonic sensors 16 within the inspection array can be orientated normally to the pipe wall for wall thickness evaluation or at an angle to the pipe wall so as to induce shear waves and identify any cracks in the pipeline, for example.

The sensor units 14 on the upstream vessel 11A define an upstream group of sensor units and the sensor units 14 on the downstream vessel 11B define a downstream group of sensor units. The sensor units 14 in the upstream group are spaced circumferentially from one another, as are the sensor units 14 in the downstream group. Hence, for each vessel 11A,11B. there is a zone of non-coverage with respect to the internal circumference of a pipe along which the apparatus 10 is travelling, that is, between the arcuate inspection arrays of adjacent sensor units 14 in each group.

To overcome this, the sensor units 14 in the downstream group are arranged out of phase with the sensor units 14 in the upstream group. The downstream group provides downstream inspection coverage for the circumferential spacing between the sensor units in the upstream group, while the upstream group provides upstream inspection coverage for the circumferential spacing between the sensor units in the downstream group. Hence, the arrangement provides 360 degrees of inspection coverage.

In the illustrated embodiment of FIG. 1, each vessel 11A,11B includes four sensor units 14, arranged at 90 degrees to one another about the longitudinal axis of the respective vessel 11A,11B. Furthermore, the sensor units 14 on the leading vessel 11A are out of phase (by 45 degrees) with the sensor units 14 on the trailing vessel 11B.

The zone of inspection coverage for each inspection array is at least enough to permit circumferential inspection (i.e. 360 degrees) of the internal surface of a pipe, by combining the inspection results from the inspection arrays on the first and second vessels 11A, 11B.

In exemplary embodiments, the inspection arrays are configured to provide a degree of overlap between the area covered by the sensor units 14 on the leading vessel 11A and the area covered by the sensor units 14 on the trailing vessel 11B. This provides for greater accuracy of inspection data, as well as accounting for misalignment between the vessels 11A,11B.

In exemplary embodiments, the circumferential extent of each inspection array is greater than the circumferential spacing between each inspection array, for each of the upstream and downstream groups.

As will be described in more detail below, each sensor unit 14 is movable between a first radial position (for example a retracted position) and a second radial position (for example an extended position). In exemplary embodiments, the zone of inspection coverage for each inspection array is at least enough to permit circumferential inspection of the internal circumference of a pipe (that is, by combining the inspection results from the inspection arrays on the first and second vessels 11A, 11B) for each radial position of the sensor units 14. Hence, 360 degrees of inspection coverage can be achieved even at the maximum radial extent of the sensor units 14.

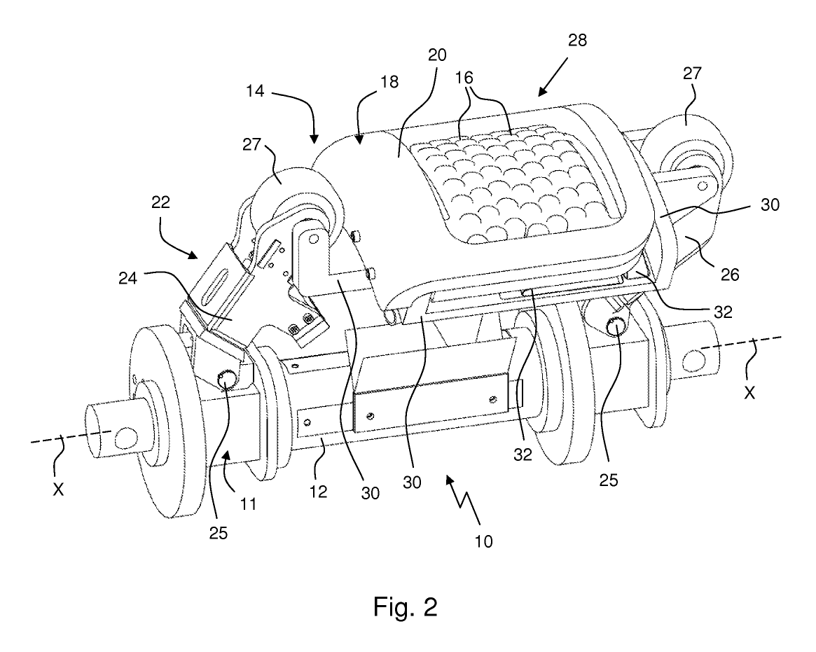

FIG. 2 is a simplified view of one of the vessels 11A, 11B, in which only one of the sensor units 14 is illustrated, for clarity of understanding.

The vessel 11 has a central body 12 with a longitudinal axis X (extending left to right as viewed in FIG. 2). A sensor unit 14 is mounted in association with said body 12. The sensor unit 14 includes an arcuate array of ultrasonic sensors 16 for inspecting a pipe wall.

The sensor unit 14 includes a skid 18 having an outer surface 20 intended to run adjacent or in contact with a pipe wall, in use. The outer surface 20 is arcuate in a circumferential direction with respect to the longitudinal axis X. The sensors 16 also define an arcuate inspection plane in a circumferential direction with respect to the longitudinal axis X. The inspection plane is arranged at a stand off from the outer surface of the skid 18 (for example, radially inward of the outer surface 20), for protecting the sensors 16 against wear or other damage from contact with the pipe wall.

The ultrasonic sensors 16 within the inspection array can be orientated normally to the pipe wall for wall thickness evaluation or at an angle to the pipe wall so as to induce shear waves and identify any cracks in the pipeline, for example.

The apparatus 10 includes a spring-loaded mechanism 22 for permitting movement of the sensor unit 14 with respect to the longitudinal axis of the central body 12, for example, in response to changes in bore diameter.

The mechanism 22 is configured for biasing the sensor unit 14 in a generally radial direction, in order to bias the outer surface 20 of the skid 18 in the direction of a pipe wall. More particularly, the mechanism 22 is configured for moving the sensor unit 14 between a first radial position (for example, a retracted position for use in a small diameter bore) and a second radial position (for example, an extended position for use in a large diameter bore), in response to changes in pipe diameter. The mechanism 22 is configured to position the sensor unit 14 at an appropriate radial position (for example, intermediate said first and second radial positions), depending on the size of the bore through which the apparatus 10 is passing. Hence, the apparatus 10 can be used for inspection of multi-diameter pipelines or across a range of pipelines having different diameters.

The mechanism 22 includes first and second suspension members 24, 26 configured for biasing the sensor unit 14 in the direction of a pipe wall (for example, in a radial or outward direction relative to the longitudinal axis X). The first and second suspension members 24, 26 are axially off set from one another, with respect to the longitudinal axis of the central body 12.

The first and second suspension members 24, 26 are connected to body 12 by a spring-biased pivotal connection 25, so as to be configured to pivot relative to said longitudinal axis of the central body 12. The suspension members 24, 26 are biased towards said second radial position (that is, an extended position relative to the body 12). Hence, the suspension members 24, 26 act as spring-biased struts or arms which are movable relative to the central body 12 of the vessel 11, for positioning the sensor unit 14 adjacent the pipe wall.

A roller 27 is provided at the end of each suspension member 24, 26, for rolling contact with the internal surface of a pipe along which the apparatus is travelling, in use. The first and second suspension members 24, 26 form part of a linkage 28, which is configured for movement of the sensor unit 14 radially with respect to the longitudinal axis of the central body 12, for example, between the first radial position and second radial position, in response to changes in bore diameter as the suspension rollers 27 react against the pipe wall.

The linkage 28 includes a carrier 30 arranged for movement with said first and second suspension members 24, 26. The sensor unit 14 is mounted on said carrier 30. The carrier 30 is mounted between the first and second suspension members 24, 26, and the carrier 30 is arranged to remain parallel with the longitudinal axis of the central body 12 during movement of the sensor unit 14.

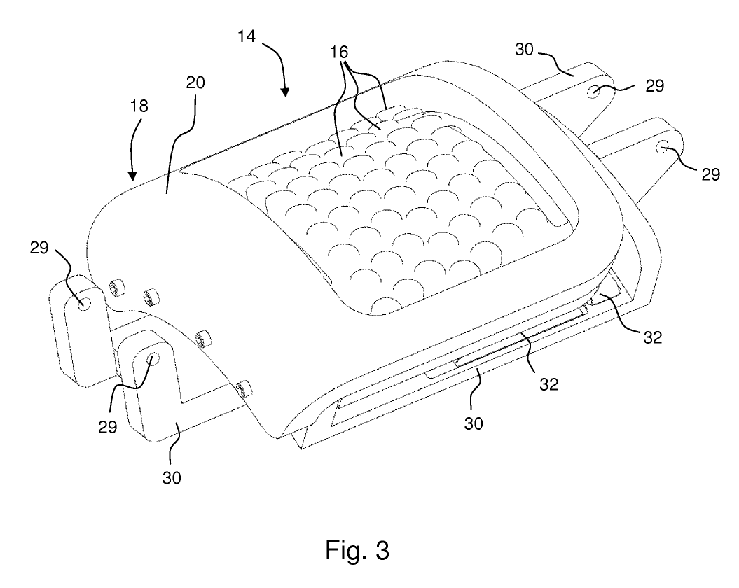

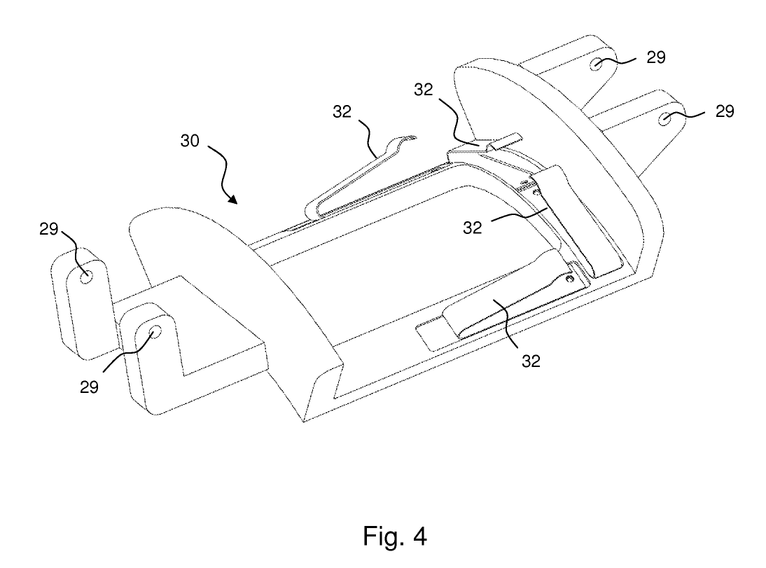

As can be seen in FIGS. 3 and 4, the carrier 30 includes pivot points 29 for connection to the first and second suspension members 24, 26. As can be seen in FIG. 4, the carrier 30 biasing elements in the form of leaf springs 32, which are arranged beneath the sensor unit 14. The biasing elements provide local biasing of the sensor unit 14 relative to the longitudinal axis of the central body 12, for example, in the direction of the pipe wall.

The spring-loaded mechanism 22 ensures that the sensors 16 are deployed adjacent the pipe wall, even in bends (where conventional systems fail or are highly unreliable). Moreover, the localised biasing of the sensor unit 14 on the carrier 30 assists in providing correct orientation and clamping force of the skid 18 against the pipe wall.

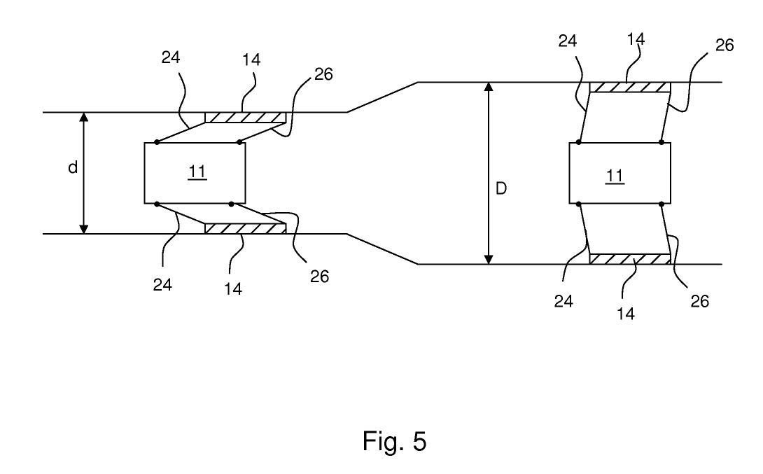

The apparatus 10 is suited for use inspecting a pipeline having a first section with a first bore diameter and a second section with a second bore diameter (that is, less than or greater than the first bore diameter). The apparatus 10 can be sent on a continuous run through said first and second sections of the pipeline. The mechanism 22 is used to bias the sensor unit 14 against an inner surface of the first section and to automatically bias the sensor unit 14 against an inner surface of the second section upon a change in bore diameter between said first and second sections of the pipeline. An example is shown in FIG. 5.

The apparatus 10 permits accurate modelling of the biasing forces required to maintain the skid 18 in contact with the pipe wall, providing a significant improvement over conventional skid designs.

The apparatus 10 is advantageous, at least insofar as it should reduce the time required to design a skid for a given diameter of pipe, by allowing the required forces to be calculated in an early stage in the design procedure, reducing or obviating the need for optimisation loops and other acts of trial and error. Moreover, the linkage 28 permits use of the apparatus across a range of pipeline diameters, including improved tracking of the pipe bore, especially in bends and through restrictive pipeline features such as tapers, valves, etc.

The linkage 28 permits use of the apparatus across a range of pipeline diameters, including improved tracking of the pipe bore. Each linkage 28 can move independently with respect to the other linkages 28 on the vessels 11A,11B. This enables the apparatus to pass through and inspect tight bend diameters and difficult or restrictive pipeline features such as tapers, valves, etc. It is envisaged that exemplary embodiments will be capable of inspection through 1D bends and mitre bends.

In the exemplary embodiment of FIG. 1, the linkage 28 takes the form of a 4-bar linkage, consisting of the body 12, suspension members 24. 26 and carrier 30. Other forms of collapsible linkage may be applicable. For example, a 5-bar linkage including said suspension members 24, 26, configured to ensure that the sensor unit 14 tracks the pipe wall irrespective of the attitude of the internal pig body 12 within the pipeline.

It should be noted that FIG. 1 shows a twin vessel arrangement with two groups of circumferentially spaced sensor units, wherein the two groups of sensor units are axially offset and out of phase, in order to provide 360 degrees of inspection coverage. However, exemplary embodiments may incorporate three or more axially offset groups of circumferentially spaced sensor units on one, two or more vessels, for providing 360 degrees of inspection coverage. Although FIG. 1 shows an embodiment in which there are four sensor units per group of sensor units, other embodiments may consist of three or more sensor units per group.

In exemplary embodiments, the apparatus 10 is configured so that the combined inspection data from the sensors 16 from the groups of sensor units 14 provides 360 degrees of coverage (with respect to a longitudinal axis of the apparatus 10) irrespective of the position of relative position of the sensor units to one another, for example if one or more of the sensor units 14 are arranged at different radial positions. This enables the apparatus 10 to provide 360 degree inspection of the internal surface of a pipeline having multiple bore diameters, or across a range of different pipe diameters.

Although FIGS. 1 and 2 are described with spring-loaded suspension members in the form of pivotable arms or struts, other types of suspension may be employed. Although FIGS. 2 to 4 are described with leaf springs for local biasing of the sensor unit on the carrier, other forms of resilient biasing element may be incorporated.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended and are understood to be within the scope of the claims.

What is claimed is:

1. An apparatus for pipeline inspection, the apparatus having a longitudinal axis and comprising:
a plurality of ultrasonic sensor units arranged for inspection of a pipe wall, each ultrasonic sensor unit comprising an array of ultrasonic sensors,
wherein the plurality of ultrasonic sensor units defines two or more groups of ultrasonic sensor units,
wherein the groups of ultrasonic sensor units are axially offset from one another with respect to the longitudinal axis of the apparatus, the ultrasonic sensor units in each group being spaced circumferentially from one another, and wherein the ultrasonic sensor units are arranged out of phase, to provide inspection coverage for the circumferential spacing between the sensor units in the groups of ultrasonic sensor units so that the combined output from the groups of sensor units provides 360 degrees of inspection coverage.

2. The apparatus according to claim 1, wherein each ultrasonic sensor unit comprises a skid having an outer surface configured to contact a pipe wall.

3. The apparatus according to claim 2, wherein each ultrasonic sensor unit is mounted on a carrier for deployment of the ultrasonic sensor unit adjacent a pipe wall, wherein the sensor unit is locally biased on the carrier for biasing the skid into contact with a pipe wall.

4. The apparatus according to claim 2, wherein each ultrasonic sensor unit is mounted on a carrier for deployment of the sensor unit adjacent a pipe wall, wherein each carrier is movable between a first radial position for a first bore diameter and a second radial position for a second bore diameter which is greater than the first bore diameter.

5. The apparatus according to claim 4, wherein each array of ultrasonic sensors defines an inspection zone, and wherein the ultrasonic sensor units are arranged so that the combined area of coverage from the inspections zones provides circumferential inspection of the internal surface of a pipe when one or more of the carriers is in the second radial position.

6. The apparatus according to claim 1, wherein each ultrasonic sensor unit is mounted on a mechanism configured to move the ultrasonic sensor unit radially with respect to the longitudinal axis of the apparatus in response to changes in pipe diameter.

7. The apparatus according to claim 6, wherein the mechanism is configured to bias the respective ultrasonic sensor unit towards a first radial position for a first bore diameter and towards a second radial position for a second bore diameter which is greater than the first bore diameter.

8. The apparatus according to claim 7, wherein each array of ultrasonic sensors defines an inspection zone, and wherein the ultrasonic sensor units are arranged so that the combined area of coverage from the inspections zones provides circumferential inspection of the internal surface of a pipe when one or more of the carriers is in said second radial position.

9. The apparatus according to claim 6, wherein the mechanism comprises first and second suspension members configured to bias a respective ultrasonic sensor unit in a radial direction, and wherein the first and second suspension members are axially off set from one another with respect to the longitudinal axis of the apparatus.

10. The apparatus according to claim 9, wherein the first and second suspension members are configured to pivot relative to the longitudinal axis of the apparatus.

11. The apparatus according to claim 1, wherein each ultrasonic sensor unit is mounted in association with a collapsible linkage configured to bias a respective ultrasonic sensor unit in the direction of a pipe wall, and configured to permit movement of the respective ultrasonic sensor unit with respect to the longitudinal axis of the apparatus, between a first radial position and a second radial position, in response to changes in pipe diameter.

12. The apparatus according to claim 1, wherein each array of ultrasonic sensors defines an arc of a circle extending in a circumferential direction with respect to the longitudinal axis of the apparatus.

13. The apparatus according to claim 1, wherein each array of ultrasonic sensors defines an inspection zone, and wherein the groups of ultrasonic sensor units are arranged to provide a degree of circumferential overlap for each inspection zone.

14. The apparatus according to claim 1, further comprising a first vessel and a second vessel coupled for movement together along a pipeline, wherein a first group of ultrasonic sensor units are mounted in association with the first vessel and a second group of ultrasonic sensor units are mounted in association with the second vessel.

15. A method of pipeline inspection for a pipeline having a first section with a first bore diameter and a second section with a second bore diameter which is greater than the first bore diameter, the method comprising:
providing a pipeline apparatus for in-line inspection of the pipeline, the apparatus having a longitudinal axis and comprising a plurality of ultrasonic sensor units arranged for inspection of a pipe wall, each ultrasonic sensor unit comprising an array of ultrasonic sensors, wherein the plurality of ultrasonic sensor units define an upstream group of sensor units and a downstream group of ultrasonic sensor units, the upstream group being axially offset from the downstream group, wherein the ultrasonic sensor units in the upstream group are spaced circumferentially from one another, the ultrasonic sensor units in the downstream group are spaced circumferentially from one another, and wherein the ultrasonic sensor units in the downstream group are arranged out of phase with the ultrasonic sensor units in the upstream group;
sending the apparatus on a continuous run through the first and second sections of the pipeline; and
using the ultrasonic sensor units to provide a circumferential inspection of the pipeline in both the first section and the second section, wherein the downstream group of ultrasonic sensor units provides downstream inspection coverage for the circumferential spacing between the ultrasonic sensor units in the upstream group, and the upstream group of ultrasonic sensor units provides upstream inspection coverage for the circumferential spacing between the ultrasonic sensor units in the downstream group.
